(19) United States
(12) Patent Application Publication
(10) Pub. No.: US 2011/0215636 A1
(43) Pub. Date: Sep. 8, 2011

(54) SPOKE ASSEMBLY FOR WHEELS

(76) Inventor: STEPHEN HUANG, TAICHUNG COUNTY (TW)

(21) Appl. No.: 13/039,561

(22) Filed: Mar. 3, 2011

(30) Foreign Application Priority Data
Mar. 4, 2010 (TW) 099203855

(51) Int. Cl. B60B 1/02

(52) U.S. Cl. 301/56

(57) ABSTRACT

A spoke assembly for wheels includes multiple spokes connected between the rim and the hub, and each spoke comprises multiple wires and a first end piece and a second end piece are connected to two ends of the spoke. The first end piece includes an elongate first shank with a first reception hole so as to securely receive the first end of the steel cable. The first shanks securely extend through the holes of the hub. The second end piece includes an elongate second shank with a second reception hole in which the second end of the spoke is securely received. A locking member extends through each of the holes in the rim and is threadedly connected to the second end piece.

### FIELD OF THE INVENTION

The present invention relates to a bicycle or autobike wheel, and more particularly, to a spoke assembly for a bicycle wheel or an autobike wheel.

### BACKGROUND OF THE INVENTION

The bicycles or autobikes are able to move forward by applying a driving force to the wheels which is connected to the bicycle frame by the hub. Generally, the wheels includes rim and tire which is mounted to the rim and the hub is located at the center of the rim. Spokes are connected between the hub and the rim to keep the shape of the rim.

The spokes have different shapes and widths such as a straight stick-like spoke, an elongate board-like spoke or a rib-like spoke. All of the spokes have the same purpose which is to maintain the rim as a round circle. The wheels have to bear the shocks from the ground and the weight of the riders so that the spokes are designed to dispense the force transmitted to the wheels. The conventional spokes for bicycle wheels are made of aluminum and two ends of the spokes are connected to the rim and the hub.

The first end of the spoke has a locking end which is threadedly connected to the rim and the second end of the spoke has a hook which hooks to the hub. A reinforcement member is received in the second end of the spoke so as to securely connect the hooks to the hub.

Another conventional spoke assembly is composed of two spokes which are made of composite material and each spoke has multiple end pieces extending from at least one end thereof. The end pieces are connected to the rim or the hub. The two spokes are integrally connected to each other and located in cross fashion on a plane.

It is noted that the spokes are arranged such that some spokes are in contact with each other, such that when the shocks are transferred to the spokes, the contact areas of the spokes cannot dispense the force away and have stress concentration which might break or deform the spokes. The end pieces are difficult to be manufactured. The conventional spokes are integral sticks or boards which do not have proper flexibility and can be broken when the shocks are severe.

The primary object of the present invention is to provide a spoke assembly wherein each spoke is composed of multiple steel wires which are spirally braided to form a steel cable, two end pieces are connected to two ends of the cable. Only one wire of a cable is in contact with another wire of the next cable, such that the rest of the wires are not affected by the stress.

Another object of the present invention intends to provide a spoke assembly wherein the steel cables can dispense the shocks transferred to the wheel.

Yet another object of the present invention intends to provide a spoke assembly wherein the spokes are easily installed and the tension of the cables can be adjusted.

### SUMMARY OF THE INVENTION

The present invention relates to a wheel which comprises a rim, a hub located at a center of the rim and multiple spokes connected between the rim and the hub. Each spoke is a steel cable which comprises multiple wires. The steel cable has a first end piece and a second end piece connected to two ends of the steel cable respectively. The first end piece is an elongate first shank which has a first reception hole and the first end of the steel cable is securely inserted in the first reception hole. The first shank extends through the hub. The second end piece is an elongate second shank which has a second reception hole so as to securely receive the second end of the steel cable. The second shank extends through the rim.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wheel with the spoke assembly of the present invention;

FIG. 2 is an exploded view to show the spoke assembly of the present invention;

FIG. 3 is a cross sectional view of the spoke assembly of the present invention;

FIG. 4 shows the spoke assembly is connected between the rim and the hub;

FIG. 5 shows that only one wire of each spoke assembly is in contact with each other;

FIG. 6 is an exploded view to show a second embodiment of the spoke assembly of the present invention, and

FIG. 7 is a cross sectional view of the spoke assembly of the present invention, in FIG. 6.

### DETAILED DESCRIPTION OF THE PREFERRED EMBODIMENT

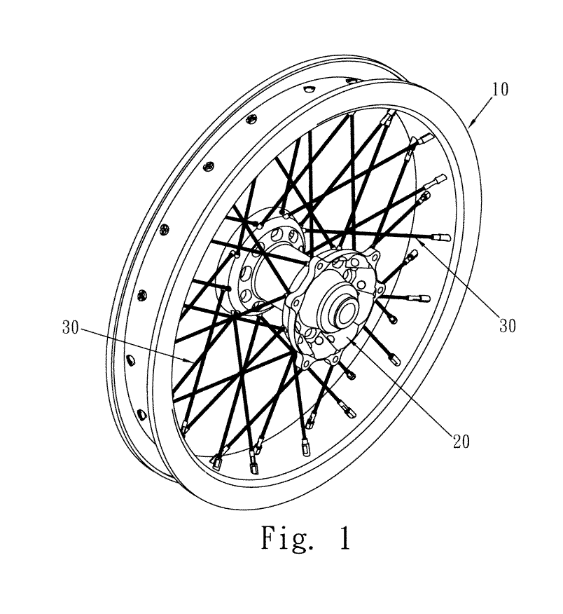

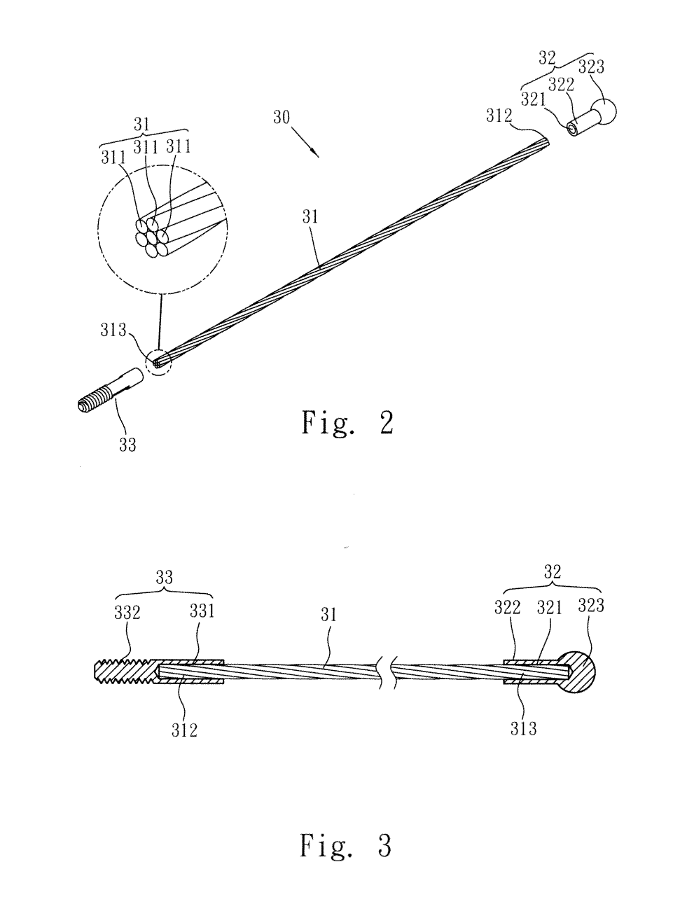

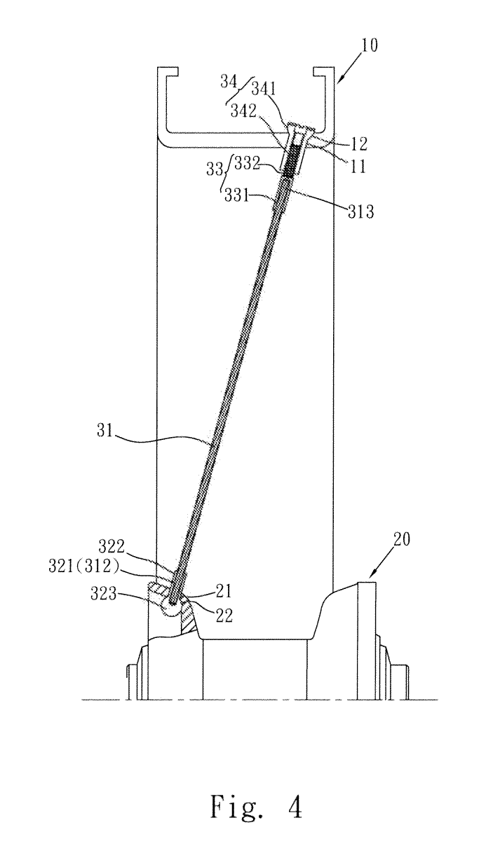

Referring to FIGS. 1 to 4, the wheel comprises a spoke assembly 30 connected between the rim 10 and the hub 20, and each spoke of the spoke assembly 30 is a steel cable 31 which comprises multiple wires 311 spirally braided to each other or weaved to each other. The steel cable 31 includes a first end 312 and a second end 313. A first end piece 32 and a second end piece 33 are respectively connected to the first and second ends 312, 313 respectively.

The rim 10 includes multiple first holes 11 defined therein and each first hole 11 includes a first positioning recess 12 defined in an outer surface of the rim 10. Each of the first positioning recesses 12 is a curved recess.

The hub 20 includes multiple second holes 21 and each second hole 21 of the hub 20 includes a second positioning recess 22 defined in an outer surface of the hub 20. Each of the second positioning recess 22 is a curved recess.

The first end piece 32 is an elongate first shank 322 which has a first reception hole 321 defined in a first end thereof. The first end 312 of the steel cable 31 is securely inserted in the first reception hole 321. The first shanks 322 of the first end pieces 32 extend through and are connected to the second holes 21 respectively. The second end piece 33 is an elongate second shank 332 which has a second reception hole 331 defined in a first end thereof and the second end 313 of the steel cable 31 is securely inserted in the second reception hole 331. The second shanks 332 extend through and are connected with the first holes 11.

Each first hole 11 has a locking member 34 connected thereto. The locking member 34 includes a positioning portion 341 which is engaged with the first positioning recess 12 and larger than the first hole 11 so that the positioning portion 341 of the locking member 34 cannot pass through the first hole 11 when the steel cable 31 is installed. A threaded portion 342 is defined in the locking member 34 and second shank 332 is threadedly connected to the threaded portion 342. The positioning portion 341 of the locking member 34 is shaped to be matched with the first positioning recess 12.

Each first shank 322 has a positioning portion 323 on a second end thereof which is engaged with the second positioning recess 22 corresponding thereto. The positioning portion 323 of each first shank 322 is larger than the second hole 21 so that the first shanks 322 cannot pass through the second holes 21 when the steel cable 31 is installed. The positioning portion 323 of the first shank 322 is shaped to be matched with the second positioning recess 22.

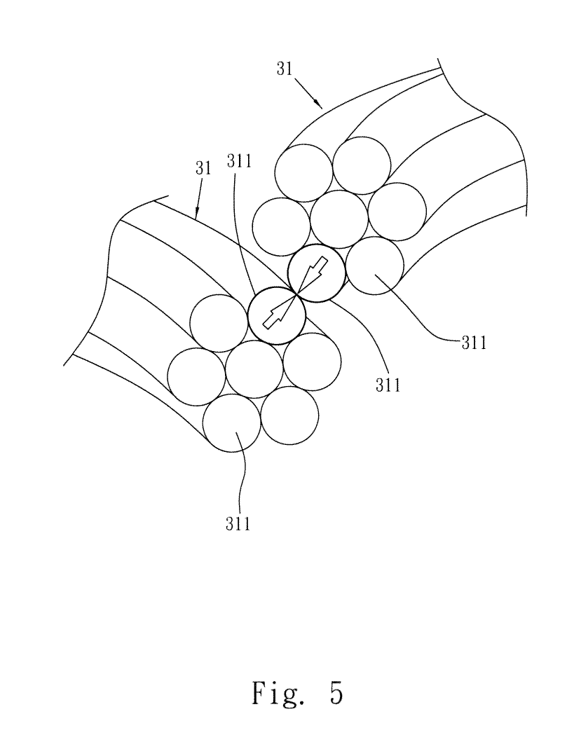

As shown in FIG. 5, when the steel cables 31 of the spoke assembly 30 are installed between the rim 10 and the hub 20, only one wire 311 of each steel cable 31 contacts another wire 311 of the next steel cable 31, so that the rest of the wires 311 are not affected and the stress concentration is happened at limited area of the steel cables 31.

The steel cable 31 comprises multiple wires 311 which dispense the shocks transferred from the ground and the size and number of the wires 311 can be varied as needed. The steel cables 31 have proper flexibility which can bear higher shocks than the conventional spokes and are suitable for the bicycles operated under extreme conditions.

The assembling steps are easy, the first end piece 32 and the steel cable 31 connected to the first end piece 32 are first extended through the second hole 21 of the hub 20 and the spherical positioning portion 323 are engaged with the second positioning recess 22. The locking member 34 is then extended through the first hole 11 of the rim 10 and threadedly connected to the second shank 332 of the second end piece 33. The positioning portion 341 of the locking member 34 is engaged with the first positioning recess 12. The tension of the steel cable 31 can be adjusted by rotating the locking member 34.

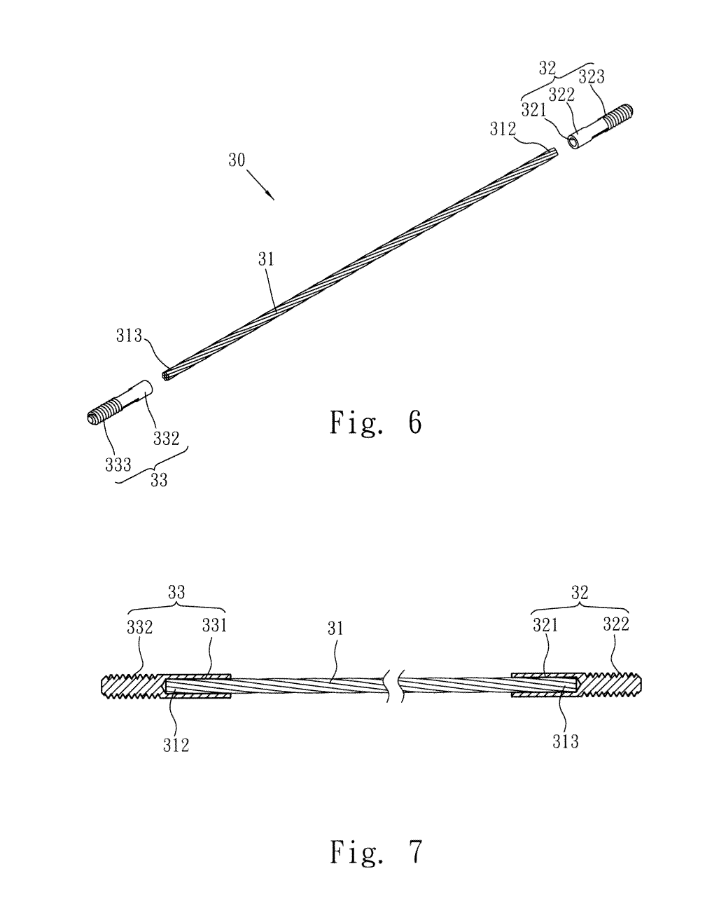

FIGS. 6 and 7 show the second embodiment of the spoke assembly 30 of the present invention, wherein the second end piece 33 includes the second reception hole 331 and the second end 313 of the steel cable 31 is securely received in the second reception hole 331. The second end piece 33 includes the second shank 332 which extends through the first hole 11 of the rim 10. The first and second ends 312, 313 of the steel cable 31 are respectively connected to the first and second end pieces 32, 33.

While we have shown and described the embodiment in accordance with the present invention, it should be clear to those skilled in the art that further embodiments may be made without departing from the scope of the present invention.

What is claimed is:

1. A wheel comprising:
a rim;
a hub located at a center of the rim;
multiple spokes connected between the rim and the hub, each spoke being a steel cable which comprises multiple wires, the steel cable having a first end and a second end, each steel having a first end piece and a second end piece connected to the first and second ends respectively;
the first end piece being an elongate first shank which has a first reception hole defined in a first end thereof, the first end of the steel cable securely inserted in the first reception hole, the first shank extending through the hub, and
the second end piece being an elongate second shank which has a second reception hole defined in a first end thereof, the second end of the steel cable securely inserted in the second reception hole, the second shank extending through the rim.

2. The wheel as claimed in claim 1, wherein the rim includes multiple first holes defined therein and the second shanks of the second end pieces are connected with the first holes.

3. The wheel as claimed in claim 2, wherein each first hole of the rim includes a first positioning recess defined in an outer surface of the rim, each first hole has a locking member connected thereto and the locking member includes a positioning portion which is engaged with the first positioning recess and larger than the first hole, a threaded portion is defined in the locking member and second shank is threadedly connected to the threaded portion.

4. The wheel as claimed in claim 3, wherein the first positioning recess is a curved recess and the positioning portion of the locking member is shaped to be matched with the first positioning recess.

5. The wheel as claimed in claim 1, wherein the hub includes multiple second holes and the first shanks of the first end pieces are connected with the second holes.

6. The wheel as claimed in claim 5, wherein each second hole of the hub includes a second positioning recess defined in an outer surface of the hub, the first shanks of the first end pieces extend through the second holes respectively, each first shank has a positioning portion on a second end thereof which is engaged with the second positioning recess corresponding thereto, the positioning portion of each first shank is larger than the second hole.

7. The wheel as claimed in claim 6, wherein the second positioning recess is a curved recess and the positioning portion of the first shank is shaped to be matched with the second positioning recess.

8. The device as claimed in claim 1, wherein each steel cable comprises multiple wires spirally braided to each other.
